(19) United States
(12) Patent Application Publication
(10) Pub. No.: US 2024/0080717 A1
(43) Pub. Date: Mar. 7, 2024

(54) HANDOVER OF A GROUP OF USER EQUIPMENT WITH INDIVIDUAL ACCESS REQUEST

(71) Applicant: BRITISH TELECOMMUNICATIONS PUBLIC LIMITED COMPANY, London (GB)

(72) Inventor: Salvador DIAZ SENDRA, London (GB)

(21) Appl. No.: 18/261,712

(22) PCT Filed: Dec. 6, 2021
(86) PCT No.: PCT/EP2021/084399

§ 371 Date: Jul. 17, 2023

(30) Foreign Application Priority Data
Jan. 18, 2021 (GB) 2100615.0

(51) Int. Cl. H04W 36/00

(52) U.S. Cl. CPC H04W 36/0009; H04W 36/0058; H04W 36/033

(57) ABSTRACT

This disclosure provides a method of operating a first User Equipment (UE) in a cellular telecommunications network, the cellular telecommunications network including a first base station and a second base station, wherein the first base station serves the first UE, the method including sending a measurement report to the first base station, the measurement report including an identifier for each UE of a plurality of UE requiring handover; and sending a handover command message to each UE of the plurality of UE requiring handover, the handover command message identifying the second base station as a handover target, so as to initiate an access request from each UE of the plurality of UE to the second base station.

### PRIORITY CLAIM

The present application is a National Phase entry of PCT Application No. PCT/EP2021/084399, filed Dec. 6, 2021, which claims priority from GB Patent Application No. 2100615.0, filed Jan. 18, 2021, each of which is hereby fully incorporated herein by reference.

### TECHNICAL FIELD

The present disclosure relates to a cellular telecommunications network.

### BACKGROUND

In a cellular telecommunications network, a handover is a process for transferring a User Equipment (UE) from a serving base station to a target base station. In a conventional handover, the UE triggers the handover when the strength of signals from its serving base station drops below a certain threshold. Following this trigger, the UE sends a report to its serving base station identifying all nearby base stations. The serving base station then selects, from this list, a target base station and sends a handover request to the target base station. Once the target base station has agreed to the handover, the handover is performed.

It has been proposed to utilize a group handover mechanism, in which a plurality of UE are handed over to a target base station. This may result in a reduction in the amount of control signaling as any message that is communicated between the UE, serving and target base stations relating to the handover may be on a per group rather than per UE basis. These group handover mechanisms have been proposed for scenarios where a plurality of UE are likely to perform the same handover (i.e. from the same serving base station to the same target base station) at the same time, such as when the plurality of UE are all being transported by the same vehicle (e.g. a car or train). One such group handover mechanism involves a UE of the plurality of UE becoming a master UE whilst the one or more other UE in the plurality of UE become follower UE. The master UE would trigger the handover and the agreement for the handover is based on the master UE's requirements. Once agreed, the master UE and all follower UE are handed over.

### SUMMARY

According to a first aspect of the disclosure, there is provided a method of operating a first User Equipment, UE, in a cellular telecommunications network, the cellular telecommunications network including a first base station and a second base station wherein the first base station serves the first UE, the method comprising sending a measurement report to the first base station, the measurement report including an identifier for each UE of a plurality of UE requiring handover; and sending an access request initiating handover command message to each UE of the plurality of UE requiring handover, the access request initiating handover command message identifying the second base station as a handover target, so as to initiate an access request from each UE of the plurality of UE to the second base station.

The method may further comprise becoming a delegate of a handover process operation for each UE of the plurality of UE; and storing data for each UE of the plurality of UE, the data including the identifier for each UE of the plurality of UE.

The method may further comprise ceasing delegation of the handover process operation for a UE of the plurality of UE.

The handover command message may be based on Device-to-Device communication. A message relating to the delegation of the handover process operation may also be based on Device-to-Device communication.

The cellular telecommunications network may include a third base station and the plurality of UE requiring handover includes a first subset and a second subset, and sending an access request initiating handover command message may include sending a first access request initiating handover command message to each UE of the first subset so as to initiate an access request from each UE of the first subset to the second base station and may further include a second access request initiating handover command message to each UE of the second subset so as to initiate an access request from each UE of the second subset to the third base station.

According to a second aspect of the disclosure, there is provided a method of operating a first User Equipment, UE, in a cellular telecommunications network, the cellular telecommunications network including a first base station and a second base station wherein the first base station serves the first UE, the method comprising delegating a handover process operation to a second UE, wherein the delegation includes sending an identifier for the first UE; suspending performance of the delegated handover process operation; receiving an access request initiating handover command message from the second UE identifying the second base station as a handover target; and responsive to the access request initiating handover command message, initiating an access request to the second base station.

The access request may include one or more of a group comprising: a request for prioritized handover for an ongoing service, a request for a network slice, a request for a level of service, and a request for an application.

The method may further comprise ceasing delegation of the handover process operation to the second UE.

The handover command message and/or a message relating to the delegation of the handover process operation may be based on Device-to-Device communication.

The delegated handover process operation may include at least one of a group comprising: performing radio frequency measurements to determine whether a handover condition is met, and sending a measurement report to the first base station identifying the first UE as requiring handover.

According to a third aspect of the disclosure, there is provided a method of operating a first base station in a cellular telecommunications network, the cellular telecommunications network including a second base station, the method comprising receiving a handover request message from the second base station, the handover request message identifying a plurality of UE requiring handover; responsive to the handover request message, sending a handover request acknowledgment message to the second base station; and receiving an access request message from each UE of the plurality of UE.

According to a fourth aspect of the disclosure, there is provided a computer program comprising instructions which, when the program is executed by a computer, cause the computer to carry out any one of the first, second or third aspect of the disclosure. The computer program may be stored on a computer readable carrier medium.

According to a fifth aspect of the disclosure, there is provided a user equipment for a cellular telecommunications network comprising at least one processor configured to carry out any one of the first or second aspects of the disclosure.

According to a sixth aspect of the disclosure, there is provided a base station for a cellular telecommunications network comprising at least one processor configured to carry out the third aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a cellular telecommunications network of an embodiment of the present disclosure, in a first state.

FIG. 2 is a schematic diagram of the cellular telecommunications network of FIG. 1, in a second state.

FIG. 3 is a schematic diagram of the cellular telecommunications network of FIG. 1, in a third state.

FIG. 4 is a schematic diagram of the cellular telecommunications network of FIG. 1, in a fourth state.

FIG. 5 is a flow diagram illustrating an embodiment of a method of the present disclosure.

### DETAILED DESCRIPTION

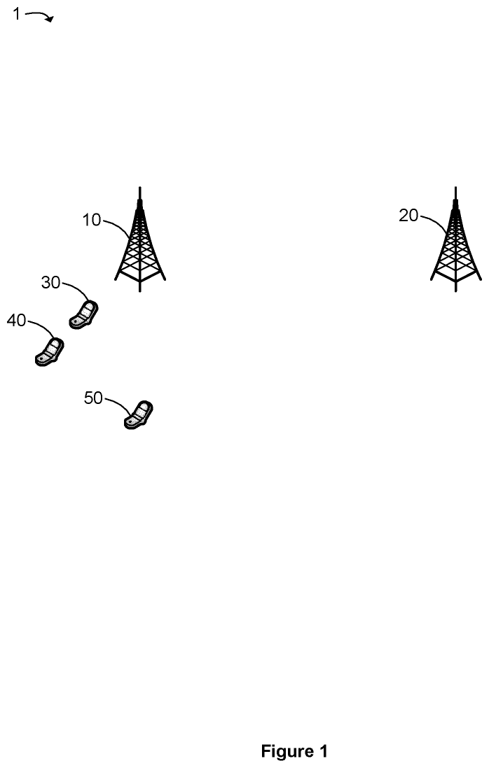

FIG. 1 illustrates a first embodiment of a cellular telecommunications network 1 of the present disclosure. The cellular telecommunications network 1 includes a first base station 10, a second base station 20, a first User Equipment (UE) 30, a second UE and a third UE 50. In this embodiment, the base stations and UE are all configured to communicate using the 5^{th} Generation (5G) protocol defined by the 3^{rd} Generation Partnership Project (3GPP) and are further configured for Device-to-Device (D2D) communications. D2D communications between any combination of the first, second and third UE 30, 40, 50 may be via indirect (i.e. being transmitted via the base station) or direct (i.e. without being transmitted via the base station). These D2D communications are generally known as “sidelink” communications.

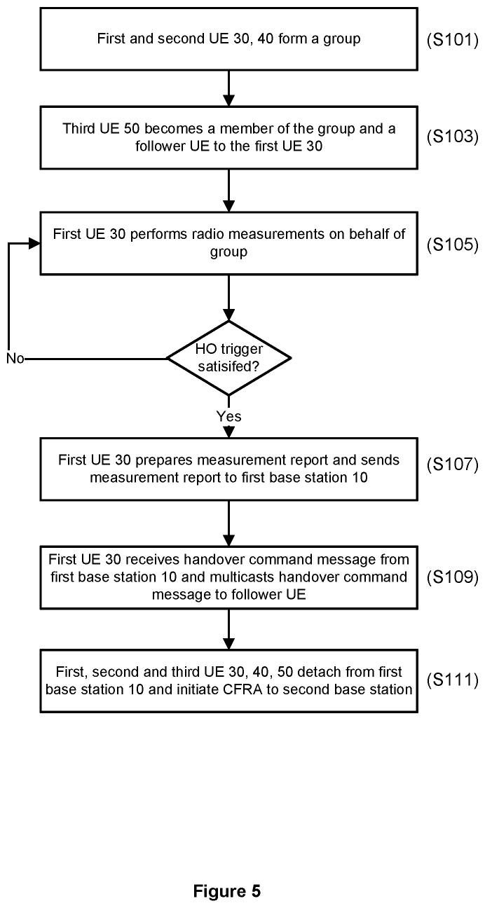

An embodiment of a method of the present disclosure will now be described with reference to FIGS. 1 to 5, in which FIGS. 1 to 4 are schematic diagrams of the network 1 in various states and FIG. 5 is a flow diagram illustrating this embodiment of the method of the present disclosure. FIG. 1 illustrates the cellular telecommunications network 1 in a first state in which the first base station 10 serves the first, second and third UE 30, 40, 50. The relationships between the first, second and third UE 30, 40, 50 are such that the first and second UE 30, 40 are able to form a group (such that they may communicate via sidelink communications) whilst the third UE 50 is not able to form a group with the first and second UEs 30, 40 (such that the third UE 30 may not communicate via sidelink communications with either the first UE 30 or second UE 40). A requirement of the relationship between a plurality of UE so that the plurality of UE may form a group may be that, in the case of direct D2D communications, that the plurality of UE are all capable of direct D2D communications and they are all discoverable by other UE in the plurality of UE, or for indirect D2D communications via a base station, that the base station identifies that the plurality of UE are all capable of D2D communications.

In this first state, in S101, the first and second UE 30, 40 form a group. The group is formed using sidelink communications and results in the first UE 30 being designated a “master” UE and the second UE 40 being designated a “follower” UE. Properties of the master UE include:
Retrieving (from the follower UE and/or other entities in the network 1, including entities that are not shown in the Figures) data for each follower UE, such as each follower UE's identity (e.g. a Cell Radio Network Temporary Identifier (C-RNTI), Sidelink RNTI (S-RNTI), or International Mobile Subscriber Identifier (IMSI)), and storing this data in memory; and
Performing one or more handover process operations on behalf of each member of the group, such as performing radio measurements to determine whether a handover trigger condition has been satisfied (e.g. the Reference Signal Received Power, RSRP, of the serving base station being less than an RSRP threshold).

Properties of each follower UE (the second UE 40 only in this first state) include:
Sending its data to the master UE; and
Suspending one or more handover process operations, such as performing radio measurements that determine whether a handover trigger condition has been satisfied (such that these one or more handover process operations are delegated to the master UE).

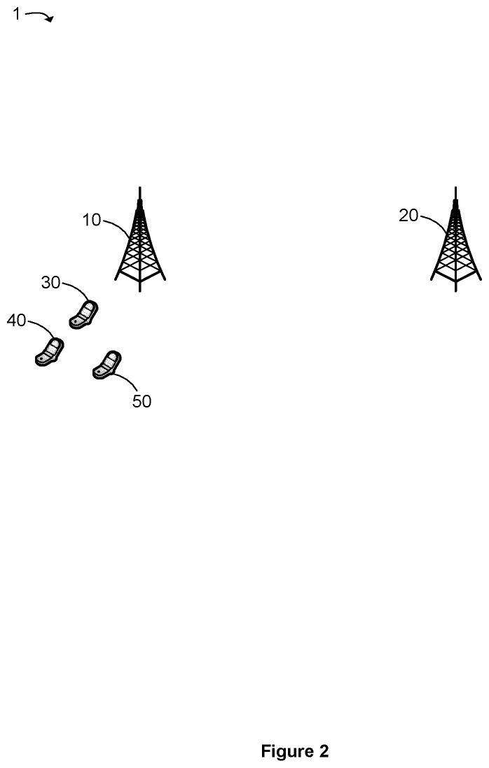

FIG. 2 illustrates the network 1 in a second state in which the third UE 50 now has a relationship with the first UE 30 and/or second UE 40 such that it may become a member of the group. In S103, the third UE 50 becomes a member of the group as a follower and the first UE 30 retrieves and stores the follower UE data for the third UE 50.

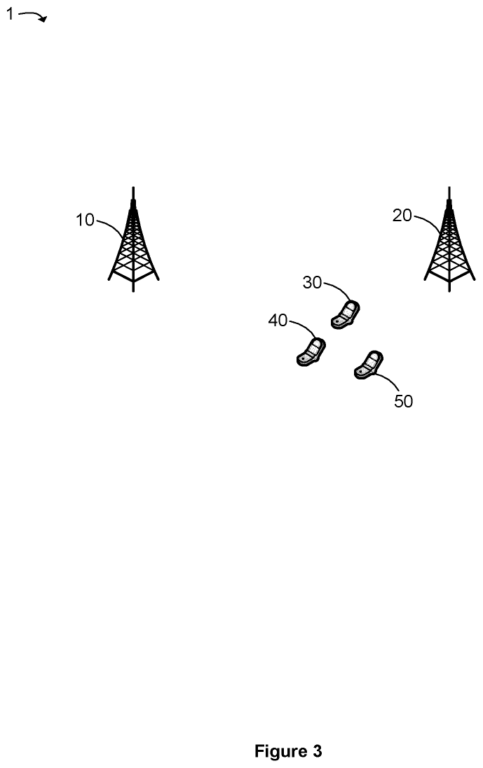

Following S103, the group of UE, including the first, second and third UE 30, 40, 50, travel on a common path from a first position (illustrated in FIG. 2) to a second position (illustrated in FIG. 3). In S105, the first UE 30, acting as a master UE, periodically performs radio measurements to determine whether a handover trigger condition has been satisfied. As the second and third UE 40, 50 are follower UE, they do not perform these radio measurements. Accordingly, the first UE 30 is performing these radio measurements on behalf of the entire group. In other words, the follower UE delegate these tasks to the master UE. In doing so, fewer resources (radio, processing and battery) are required to determine whether all members of the group satisfy the handover trigger condition relative to an alternative scenario in which each UE performs its own radio measurements to make this determination. In this example, the handover trigger condition is satisfied and the process continues to S107.

In S107, the first UE 30 prepares a measurement report and sends the measurement report to the first base station 10 (its serving base station). This measurement report is enhanced to identify each member of the group (i.e. the master UE and each follower UE). The first base station 10 then sends a handover request message to the second base station 20 (the target base station in this example), which also identifies each member of the group (i.e. the master UE and each follower UE) that are requesting handover to the second base station 20. In this example, the second base station 20 accepts the handover request by sending a handover request acknowledgment to the first base station 10, and the first base station 10 then sends a handover command message to the first UE 30. The handover command message includes parameters (such as the reserved access grants) required for each member of the group (the master UE and each follower UE) to complete a handover to the second base station 20.

On receipt of the handover command message from the first base station 10, in S109, the first UE 30 multicasts the handover command message (including the parameters required to complete the handover to the second base station 20) to the second and third UE 40, 50.

In S111, the first, second and third UE 30, 40, 50 individually detach from the first base station 10 and each initiate a Contention Free Random Access (CFRA) procedure to the second base station 20. These CFRA procedures are specific to each UE such that each UE requests an access type to the second base station 20 that is specific to the UE, such as access to a particular network slice, access at a particular level of service, and/or prioritized access based on an ongoing service. Following the CFRA procedures, the handover of the group is complete.

The above embodiment therefore enjoys the benefits of reduced control signaling and reduced battery consumption through a group handover process (compared to each UE performing the full handover process in isolation), but enjoys an additional benefit in that each UE individually requests access to the target base station based on its own requirements. For example, if one member of the group requires a preferential access type requiring more resources of the target base station, but another member of the group does not require such preferential access, then access between these members of the group and the target base station can be tailored accordingly. This would not be possible in an alternative solution in which the access request is performed by the master UE on behalf of the follower UE. That is, in such an alternative solution, the master UE would either request preferential access for all UE of the group of UE, which would waste resources for the subset of UE of the group of UE that do not require preferential access, or would request an access type that does not meet the preferential access requirements and the subset of UE of the group of UE that require preferential access risk poor quality of service.

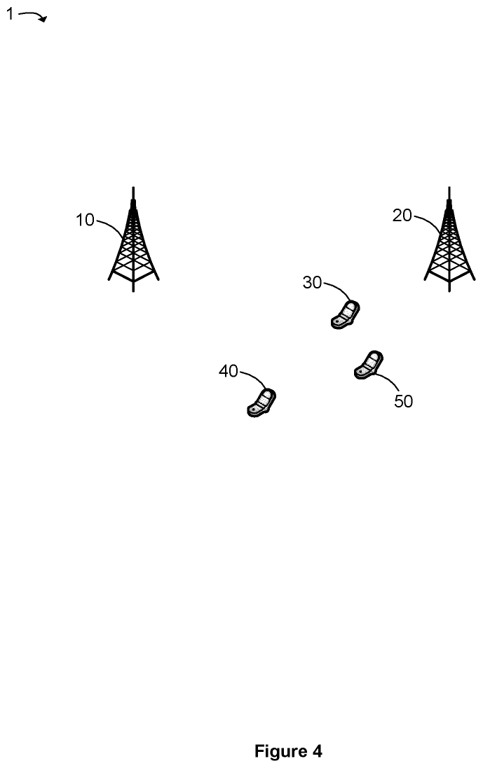

A further operation of this first embodiment is for a follower UE to cease membership of the group. This may occur, for example, when a follower UE's relationship with other members of the group is such that sidelink communications cannot be reliably transmitted. FIG. 4 illustrates a further state of the network 1 in which the second UE 40 has moved to a position relative to the other members of the group such that it exchanges one or more messages with the master UE to deregister from the group (that is, to cease delegation of the one or more handover process operations to the master UE). This deregistration process ensures that the master UE does not trigger a group handover procedure when such a group handover would be inappropriate for one or more members. Once the follower UE has deregistered from the group, it may perform conventional (individual) handover procedures or become part of another group.

In the above embodiment, the master UE is part of the group that is handed over to the target base station. However, this is non-essential, as a master UE may perform the one or more handover process operations on behalf of a group of UE for which it is not a member. Furthermore, these one or more handover process operations may be performed on subsets of the group of UE.

Furthermore, the master UE may perform these one or more handover process operations such that one or more UE of the group of UE are transferred to a different target base station than one or more other UE of the group of UE. For example, the master UE may determine that the characteristics of a first target base station are suited to a first subset of the group of UE, and that the characteristics of a second target base station are suited to a second subset of the group of UE, and proceed to perform the remaining handover process operations for each subset (such as the exchange of handover request/acknowledgement messages with the respective target base stations, and the multicasting of the handover command messages to the respective subsets of the group of UE).

In S107 above, the second base station accepts the handover of all UE in the group of UE. However, this is non-essential as the second base station may reject one or more UE of the group of UE (whilst the remaining UE of the group of UE complete the handover according to the operations described above).

The skilled person will understand that any combination of features is possible within the scope of the disclosure, as claimed.

1. A method of operating a first User Equipment (UE) in a cellular telecommunications network, the cellular telecommunications network including a first base station and a second base station wherein the first base station serves the first UE, the method comprising:
sending a measurement report to the first base station, the measurement report including an identifier for each UE of a plurality of UE requiring handover;
receiving a handover command message from the first base station, the handover command message including parameters required for each UE of the plurality of UE to complete a handover to the second base station; and
sending an access request initiating handover command message to each UE of the plurality of UE requiring handover, the access request initiating handover command message identifying the second base station as a handover target, so as to initiate an access request from each UE of the plurality of UE to the second base station.

2. The method as claimed in claim 1, further comprising:
becoming a delegate of a handover process operation for each UE of the plurality of UE; and
storing data for each UE of the plurality of UE, the data including the identifier for each UE of the plurality of UE.

3. The method as claimed in claim 2, further comprising ceasing delegation of the handover process operation for a UE of the plurality of UE.

4. The method as claimed in claim 1, wherein the handover command message is based on Device-to-Device communication.

5. The method as claimed in claim 2, wherein a message relating to the delegation of the handover process operation is based on Device-to-Device communication.

6. The method as claimed in claim 1, wherein the cellular telecommunications network includes a third base station and the plurality of UE requiring handover includes a first subset and a second subset, and sending the access request initiating handover command message includes sending a first access request initiating handover command message to each UE of the first subset so as to initiate an access request from each UE of the first subset to the second base station, and further includes a second access request initiating handover command message to each UE of the second subset so as to initiate an access request from each UE of the second subset to the third base station.

7. A method of operating a first User Equipment (UE) in a cellular telecommunications network, the cellular telecommunications network including a first base station and a second base station wherein the first base station serves the first UE, the method comprising:
delegating a handover process operation to a second UE, wherein the delegating includes sending an identifier for the first UE;
suspending performance of the delegated handover process operation;
receiving an access request initiating handover command message from the second UE identifying the second base station as a handover target; and
responsive to the access request initiating handover command message, initiating an access request to the second base station.

8. The method as claimed in claim 7, wherein the access request includes one or more of:
a request for prioritized handover for an ongoing service,
a request for a network slice,
a request for a level of service, or
a request for an application.

9. The method as claimed in claim 7, further comprising: ceasing delegation of the handover process operation to the second UE.

10. The method as claimed in claim 7, wherein at least one of the handover command message or a message relating to the delegation of the handover process operation is based on Device-to-Device communication.

11. The method as claimed in claim 7, wherein the delegated handover process operation includes at least one of:
performing radio frequency measurements to determine whether a handover condition is met, or
sending a measurement report to the first base station identifying the first UE as requiring handover.

12. A non-transitory computer-readable storage medium storing a computer program comprising instructions which, when the computer program is executed by a processing unit of a user equipment, cause the user equipment to carry out the method of claim 1.

13. A system comprising at least one processor and memory configured to carry out the method of claim 1.

14. A method of operating a first base station in a cellular telecommunications network, the cellular telecommunications network including a second base station, the method comprising:
receiving a handover request message from the second base station, the handover request message identifying a plurality of user equipment (UE) requiring handover;
responsive to the handover request message, sending a handover request acknowledgment message to the second base station; and
receiving an access request message from each UE of the plurality of UE.

15. A non-transitory computer-readable storage medium storing a computer program comprising instructions which, when the program is executed by a processing unit of a base station, cause the base station to carry out the method of claim 14.

16. A system comprising at least one processor and memory configured to carry out the method of claim 14.

17. A user equipment for a cellular telecommunications network comprising at least one processor configured to carry out the method of claim 1.

18. A base station for a cellular telecommunications network comprising at least one processor configured to carry out the method of claim 14.
